(19) United States
(12) Patent Application Publication
(10) Pub. No.: US 2006/0212577 A1
(43) Pub. Date: Sep. 21, 2006

(54) Method and deivce for network operator information retrieval

(76) Inventor: Axel Kohnke, Dulmen (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/556,225

(22) PCT Filed:
(86) PCT No.: PCT/IB04/01812

(51) Int. Cl. H04M 1/64; G06F 15/16

(52) U.S. Cl. 709/227; 379/88.1

(57) ABSTRACT

The present invention relates to an information retrieval concerning information about telecommunication network operators. In particular, the present invention relates to a method for an automatic information retrieval of public land mobile network (PLMN) operators serving telephony services of subscribed mobile communication terminals. For instance, automatic retrieval of network information about network operators serving for telephony services of a communication terminal identified by a telephone number may be performed wherein a request is coded by the terminal which comprises one or more telephone numbers. The request is transmitted to a network serving entity for performing the network information retrieval. The network serving entity receives the request which is decoded to extract the one or more telephone numbers and on the basis of the one or more telephone numbers network information is retrieved. A response is coded which includes the retrieved network information and the coded request is transmitted to the communication terminal from which the request has being originally transmitted. The communication terminal receives the corresponding response comprising network information relating to the one or more telephone numbers. The response is decoded to extract the network information and it is stored accordingly in conjunction with the one or more telephone numbers.

The present invention relates to an information retrieval concerning information about telecommunication network operators. In particular, the present invention relates to a method for an automatic information retrieval of public land mobile network (PLMN) operators serving telephony services of subscribed mobile communication terminals.

In most industrialized countries telephony services have been formerly operated by mainly state-owned monopoly telephony service operators. Today, the markets of telephony services are deregulated such that telephony services are offered and operated by several independent telecommunication network operators who compete with each other. That is, a user of telephony services is customer of one of the several independent telecommunication network operators, which switches and negotiates communication connection, respectively, initiated by a user denoted as initiator to another user denoted as recipient. The recipient is also customer of one of the several independent telecommunication network operators but not necessarily of the same as the initiator. So the communication connection between the initiator and the recipient is either established in a communication network of one telecommunication network operator or handled by at least two telecommunication network operators routed therebetween via one or more communication handing over nodes, which interconnect the communication networks of the at least two telecommunication network operators involved.

The competition situation between the independent telecommunication network operators leads to different chares depending among others on the involved communications networks to be employed for establishing the communication connection. That is, a communication connection, which is established within a communication network of one telecommunication network operator, is less charged than in case the communication connection is established within two communication networks of different telecommunication network operators.

The disadvantages for users of telecommunication services within a telephony market serviced by several independent telecommunication network operators will be described more in detail with a view to the German mobile telephony service market which is illustrated as an example for the actual situation in other countries. More particularly, the exemplary explanation will be given with respect to public land mobile telephony service operators. Until the fourth quarter of the year 2002, the operators of public land mobile networks (PLMN) blocked the distribution of telephone numbers of their range to alien operators. That means, a state regulatory entity allocated on demand a block of telephone numbers which is distinguished by a typical dialing code which is formed of a prefix sequence of digits, for example four digits. An individual sequence of digits is added to the dialing code placed first such that the resulting sequence of digits forms an unambiguous telephone numbers. Due to the fact that each block of telephone numbers is assigned to one certain public land mobile telephony service operator the initiators of a telephony communication connection (such as a telephone call) were able to identify unambiguously the identity of the public land mobile telephony service operator that serves the recipient by identifying the dialing code. Consequently, the initiators were also able to at least estimate the costs of the initiated telephony communication connection.

The situation has changed in the fourth quarter of 2002. Users of mobile terminal devices got allowed to change to another public land mobile telephony service operator while keeping their telephone number. Therefore, the identification of the public land mobile telephony service operator serving telephony services for a certain telephone number is not transparent any more to the initiators of a call. The formerly assigned dialing codes are not unambiguously assigned to respective public land mobile telephony service operator any longer. Due to the differently applied charges arising for calls into different networks of public land mobile telephony service operators it is desirable for initiators of telephony communication connections to be informed about the name (identity) of the public land mobile telephony service operators that is targeted by the telephony communication connection.

It shall be noted that the above-presented description, which has been explained on the basis of public land mobile networks (PLMN), is not limited to those public land mobile networks (PLMN). Analogously, the same problem is present within conventional telephone networks, which are based on wired communication connections and also operated by several independent telephony service operators. Moreover, the problem even exists in communications between public land mobile networks and conventional telephone networks.

The object of the present invention is to provide a method for information retrieval about a telephony service operator of a recipient of a communication connection previous to an establishing of a communication connection (a telephone call) to the recipient, which is routed via the telephony service operator.

The object of the present invention is achieved with methods for information retrieval as defined in claim 1, claim 9 and claim 14, with devices for information retrieval as defined in claim 18 and claim 19 and with a system for information retrieval as defined in claim 21. Embodiments of the invention are defined by the dependent claims.

According to an aspect of the present invention, a method for network information retrieval is provided. In particular a method for retrieval of network information about network operators associated with a telephone number is provided. More particularly, the network operators serve telephony services. To perform the method, a request is coded which comprises one or more telephone numbers. Th request is transmitted to a network serving entity for performing the network information retrieval and a corresponding response is received from the network serving entity in consequence on the request. The response comprises network information about network operators relating to the one or more telephone numbers. The response is decoded to extract the network information and the network information is stored accordingly in conjunction with the one or more telephone numbers.

According to an embodiment of the present invention, the response is structured into at least one information record. Each of the information records comprised in the response includes one telephone number of the one or more telephone numbers and a network information relating to this one telephone number such that network information is associated with a certain telephone number and is identifiable.

According to an embodiment of the present invention, the one or more telephone numbers are chosen from a plurality of telephone numbers stored in a telephone directory of the communication terminal. The telephone directory may be a digital (electronic) telephone directory editable by the user. Such a telephone directory may be also embodied and designated as contact directory including a plurality of contact entries each of which includes for example a designation, one or more telephone number, an address, etc. That is, a contact and contact entry may serve, respectively, to manage telephone, address and personal information about a person.

According to an embodiment of the present invention, a user of the communication terminal may perform manually the selecting of the one or more telephone numbers from the telephone directory and contact directory, respectively. The manual selection may operable with instructions inputted via inputting means of the communication terminal (such as keys, switches, actuators etc.)

According to an embodiment of the present invention, the selecting of the one or more telephone numbers from the telephone directory and contact directory, respectively, is automatically performed in accordance with a pre-defined selection definition. The pre-defined selection definition may define a set of telephone numbers, which are stored in the telephone directory and which comprises all telephone numbers, newly generated telephone numbers, telephone numbers which relate to communication terminals associated with in public land mobile networks (PLMNs), user-defined selection of telephone numbers and the like, to perform the automated selection correspondingly.

According to an embodiment of the present invention, the telephone directory adapted to store a plurality of telephone directory entries and the contact directory is adapted to store a plurality of contact directory entries, respectively. Each telephone/contact directory entry includes at least a designation such as a name and a telephone number. The at least one telephone/contact directory entry to which the at least one information record relates is identified on the basis of the one telephone number which is included in the corresponding information record. The network information of one of the at least one information record is stored in the telephone/contact directory by including this network information into the at least one identified telephone/contact directory entry.

According to an embodiment of the present invention, the network information comprises at least information about a network operator and in particular information about an identity of the network operator. An information about the network operator identity may be an unambiguous coding sequence relating the network operator.

According to an embodiment of the present invention, the network information comprises also charging information and in particular charging information about the network operator in accordance to which network information has being retrieved.

According to an aspect of the present invention, a method for network information retrieval is provided. In particular a method for serving retrieval about network operators associated with a telephone number is provided. More particularly, the network operators serve telephony services. A request is received from a communication terminal. The request comprises one or more telephone numbers. The request is decoded to extract the one or more telephone numbers and on the basis of the one or more telephone numbers a network information about the operator is retrieved. A response is coded which includes the retrieved network information and the coded request is transmitted to the communication terminal from which the request originated.

According to an embodiment of the present invention, the retrieving may include an accessing to one or more data storages and in particular to one or more database. The data storages and the databases are for managing and handling network information, respectively, which is associated with a plurality of telephone numbers and the retrieval of network information is adapted to obtain network information relating to the telephone numbers on the basis of which the retrieval is performed.

According to an embodiment of the present invention, the coded response is structured into information records. Each information record includes one telephone number of the one or more telephone numbers of the request and network information, which relates to this one telephone number. The number of information records depend on the number of telephone numbers originally included in the received request and may depend on the network information retrieval success. That is, in case network information is unavailable an information record is not created (coded), in case information is available an information record in the response is created (coded).

According to an embodiment of the present invention, the network information comprises at least information about a network operator and in particular the network information comprises at least information about an identity of the network operator.

According to an embodiment of the present invention, the network information comprises additionally charging information.

According to an aspect of the present invention, a method for network information retrieval is provided. In particular the method is provided for retrieval of network information about network operators serving telephony services for a communication terminal identified by a telephone number. To perform the method, a request is coded which comprises one or more telephone numbers. Th request is transmitted to a network serving entity for performing the network information retrieval. The network serving entity receives the request is received from the communication terminal. The request is decoded to extract the one or more telephone numbers and on the basis of the one or more telephone numbers network information about network operators is retrieved. A response is coded which includes the retrieved network information and the coded response is transmitted to the communication terminal from which the request has originated. The corresponding response is received by the communication terminal from the network serving entity in response to the request. The response comprises network information relating to the one or more telephone numbers. The response is decoded to extract the network information and the network information is stored accordingly in conjunction with the one or more telephone numbers.

According to an aspect of the invention, there is provided a computer program product for network information retrieval. The computer program comprises program code portions directly loadable into a local memory of a microprocessor based component, processing device, a terminal device, a communication terminal device a serving device or a networked device for carrying out the operations of the aforementioned methods when the program is executed thereon.

According to an aspect of the preset invention, a computer program product for network information retrieval is provided which comprises program code portions stored on a computer readable medium for carrying out the aforementioned methods when the program product is executed on a microprocessor based component, processing device, a terminal device, a communication terminal device a serving device or a networked device.

According to an aspect of the preset invention, a software tool for network information retrieval is provided. The software tool comprises program portions for carrying out the operations of the aforementioned methods when the software tool is implemented in a computer program and/or executed.

According to an aspect of the preset invention, a computer data signal is provided which is embodied in a carrier wave and represents instructions which when executed by a processor cause the operations of anyone of the aforementioned methods to be carried out. Thereby Internet applications of the invention are covered.

According to an aspect of the present invention, a communication terminal is provided. In particular, the communication terminal is adapted to perform the method for network information retrieval according to an embodiment of the invention. The communication terminal comprises a coding component, a communication interface, a decoding component and a storing component. The request coded by the coding component comprises at least one or more telephone numbers. The communication interface is employed to convey this request to a network serving entity, which answers to request by transmitting back a response, which is received again by the communication interface. The decoding component is adapted to decode and extract network information included in the received response. The network information relates to the one or more telephone numbers originally comprised in the request. The storing component is adapted to include the network information into a telephone directory and contact directory, respectively; wherein the storing is performed on the basis of the telephone numbers relating to the extracted network information.

According to an aspect of the present invention, a network serving entity is provided. In particular the network serving entity is adapted to perform the method for network information retrieval according to an embodiment of the invention. The network serving entity comprises a communication interface, a decoding component, a retrieval component and a coding component. The communication interface component is for receiving a request from a communication terminal and for transmitting a response to the communication terminal. The decoding component is adapted to decoding the request, which includes one or more telephone numbers, and to extract the one or more telephone numbers. The retrieving component is adapted to retrieve network information in accordance with the one or more telephone numbers. The coding component is adapted to code the response, which comprises the retrieved network information.

According to an aspect of the present invention, a system for network information retrieval is provided. The system comprises at least one communication terminal and at least one network serving entity.

The communication terminal comprises a coding component, a communication interface, a decoding component and a storing component. The request coded by the coding component comprises at least one or more telephone numbers. The communication interface is employed to convey this request to a network serving entity, which answers to request by transmitting back a response, which is received again by the communication interface. The decoding component is adapted to decode and extract network information included in the received response. The network information relates to the one or more telephone numbers originally comprised in the request. The storing component is adapted to include the network information into a telephone directory and contact directory, respectively, wherein the storing is performed on the basis of the telephone numbers relating to the extracted network information.

The network serving entity comprises a communication interface, a decoding component, a retrieval component and a coding component. The communication interface component is for receiving a request from a communication terminal and for transmitting a response to the communication terminal. The decoding component is adapted to decoding the request and to extract the one or more telephone numbers. The retrieving component is adapted to retrieve network information in accordance with the one or more telephone numbers. The coding component is adapted to code the response, which comprises the retrieved network information.

The accompanying drawings are included to provide a further understanding of the invention and are incorporated in and constitute a part of this specification. The drawings illustrate embodiments of the present invention and together with the description serve to explain the principles of the invention. In the drawings,

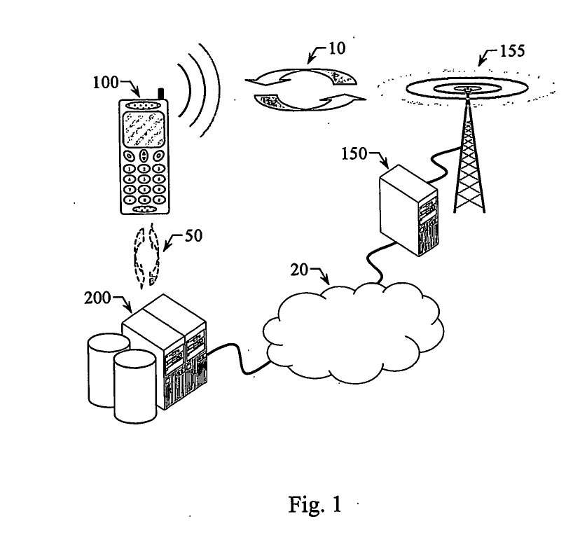

FIG. 1 shows a system, which allows retrieving network information according to an embodiment of the present invention;

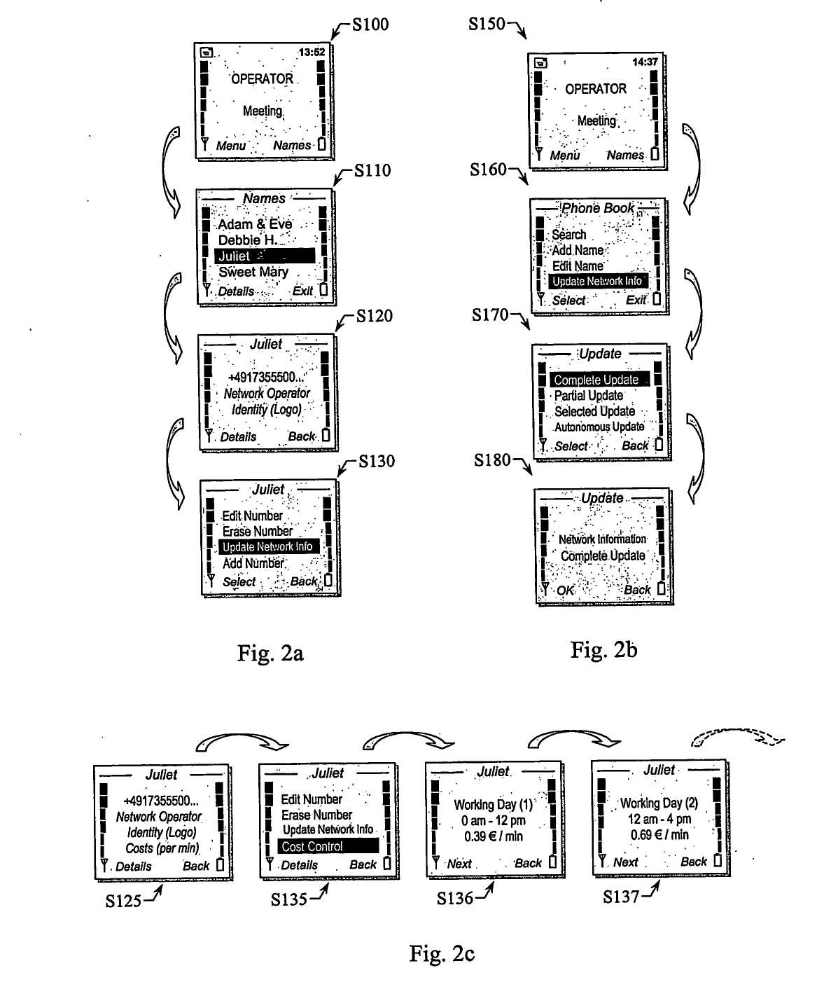

FIG. 2a shows first example illustrations of a user interface of a communication terminal which operates a method for information retrieval according to an embodiment of the present invention;

FIG. 2b shows second example illustrations of a user interface of a communication terminal which operates a method for information retrieval according to an embodiment of the present invention;

FIG. 2b shows alternative example illustrations of a user interface of a communication terminal with respect to those example illustrations depicted in FIG. 2a;

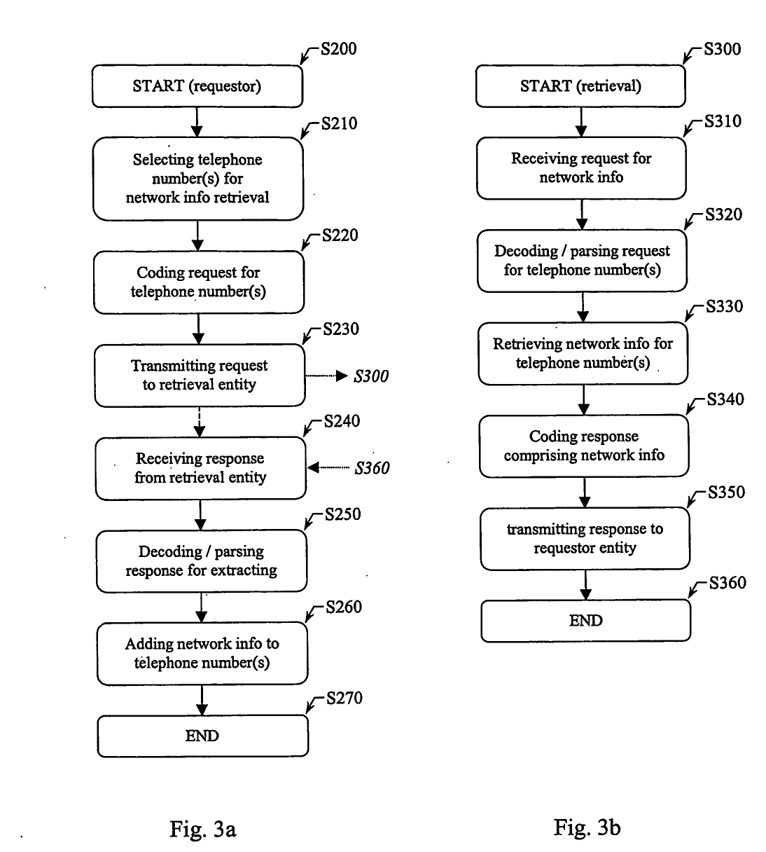

FIG. 3a shows a first flow chart illustrating a method for information retrieval according to an embodiment of the present invention;

FIG. 3b shows a second flow chart illustrating a method for information retrieval according to an embodiment of the present invention;

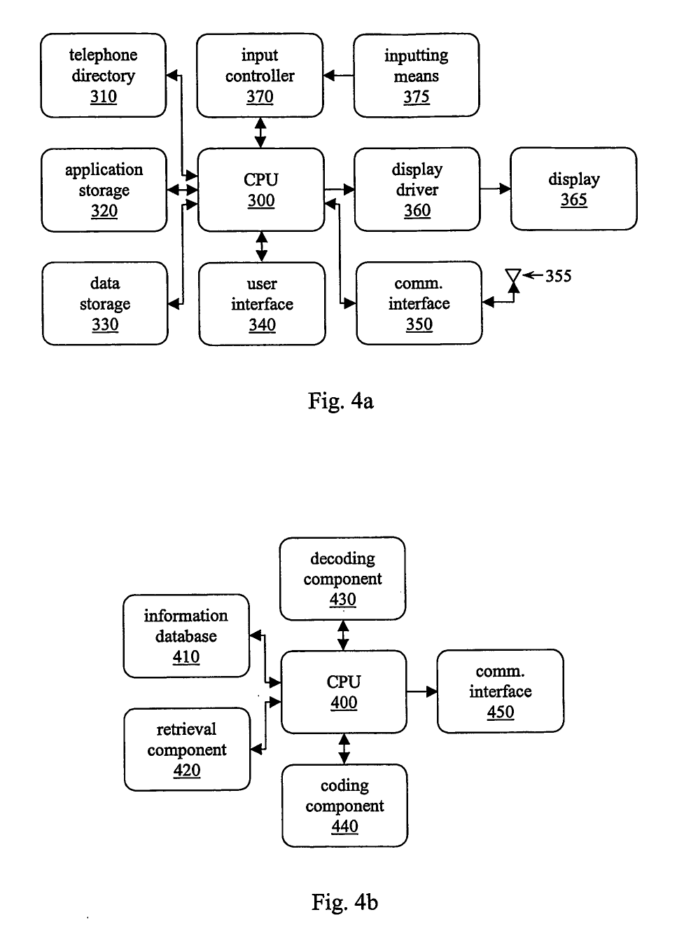

FIG. 4a shows components of a communication terminal according to an embodiment of the present invention; and

FIG. 4b shows components of a network serving entity according to an embodiment of the present invention.

Reference will be made in detail to the embodiments of the invention, examples of which are illustrated in the accompanying drawings. Wherever possible the same reference numbers are used in the drawings and the description to refer to the same or like parts.

The following description refers to public land mobile networks analogously to the introduction on the basis of which the problems to be overcome by the present invention have being indicated. It shall be understood that the present invention is not limited to public land mobile networks but also applicable to conventional wired telephone networks.

FIG. 1 shows a system, which comprises example components to allow retrieval of network information according to an embodiment of the present invention. The basic idea of the present invention is to enable a user of a communication terminal such as a mobile phone 100 to retrieve network information about at least the PLMN operator identity which operates telephony services for a recipient of a communication call. Therefore the recipient is addressable by the means of a certain telephone number. The network information is provided by a dedicated networked information service operated on a network serving entity such as a network information server 200 illustrated in FIG. 1. The network information is retrieved by the communication terminal from the network serving entity operating the dedicated networked information service by transmitting a request for retrieval. The request for retrieval is answered by the dedicated networked information service by transmitting back a corresponding request response containing the requested network information. The exchange of request and response is indicated in FIG. 1 as arrows 50.

In the field of mobile communication, the communications of requests and responses are routed via a PLMN. In detail, an appropriate communication path shall be illustrated on basis of the components presented in FIG. 1. The mobile phone 100 representing a communication terminal communicates via its over-the-air (OTA) interface with a base station 150 to which it is currently associated. One or more intermediately arranged network devices 160, such as router devices, gateway devices, proxy devices and the like may be involved in the routing of the communications received via the base station 150 to the network information server 200 and vice versa Generally, the communications between mobile phone 100 and network information server 200 is conveyed through one or more data communication networks interconnecting both the mobile phone 100 and network information server 200. One of the data communication networks is a wireless data communication network, in particular a PLMN allowing mobile data communications. Further data communication networks may be wire-based data communication networks such local area network (LAN), wide area network (WAN), illustrated in a general form and referred to as reference number 20, and similar or related networks allowing data communications.

The network information retrieval presented in the present invention is based on a request message/response message sequence. That is, messages are exchanged between the participating devices which are on the one side the communication terminal embodied as mobile phone 100 and on the other side the network serving entity embodied as network information server 200. Generally for operating the aforementioned message sequence, an appropriate logical communication connection may be established interconnecting the participating devices via one or more data communication networks. The logical communication connection may be provided by any communication networks in combination with data communication bearers and transport protocols. A suitable communication network may be a local area network (LAN), a wide area network (WAN) which may also comprise the internet but also local wire-based serial networks such as universal serial bus (USB) or standardized serial communication (e.g. RS-323).

The devices (i.e. the communication terminal embodied as mobile phone 100 and the network serving entity embodied as network information server 200) may be also connected via a wireless communication network such as a mobile network supporting global system for mobile communication (GSM) services and/or supporting general packet radio services (GPRS), a third generation mobile communication network such as a universal mobile telecommunication system (UMTS) network, a wireless local area network (WLAN), a Bluetooth network or an infrared network (IrDA). The logical communication connection between the participating devices may be provided by a single communication network of the aforementioned type but also may be provided by several communication networks of the aforementioned types interconnected by dedicated network routing devices.

The request and response messages can be implemented on the top of appropriate protocols in accordance with the type of employed communication network. Appropriate protocols on top of which the request and response messages may be implemented are the hypertext transfer protocol (HTTP), the wireless session protocol (WSP) of the wireless application protocol (WAP) standard, wireless datagram protocol (WDP), the object exchange protocol (OBEX) used for cable connections, such as universal serial bus (USB) or RS-232, for short-range radio frequency connections, such as Bluetooth, or for infrared connections (IrDA), the transport control protocol/internet protocol (TCP/IP) stack and on top of the transport layer service which is offered by the e-mail protocol (e.g. simple mail transfer protocol, SMTP). Transfer at the lower layer can be performed according to the underlying network using e.g. short messages SMS (short message service) or other signaling type transmission methods (e.g. USSD; unstructured supplementary service data), circuit-switched data calls or packet-switched data transfer services.

It shall be noted that handling, routing and transferring of data communications is out of the scope of the present invention and conventional or future network communication devices, communication bearers, data coding methods and communication methods are employed therefor.

FIGS. 2a and 2b show possible applications of the method for network information retrieval according to an embodiment of the present invention. The illustrated application relates again also to the field of mobile communication and particularly to the field of a user interface of a mobile communication terminal. FIG. 2a as well as FIG. 2b illustrate a selection of display illustrations and screen shots, respectively, which are presented to a user of a communication terminal such as the mobile phone by the implemented user interface which allows the user to operate the communication terminal. With respect to FIG. 2a and in accordance with a further embodiment of the present invention FIG. 2c shows possible alternative selections of display illustration and screen shots, respectively.

In a screen shot S100 a typical user interface illustration of a communication terminal is shown which is in a standby mode. The shown user interface illustration comprises a level indicator, indicating a strength or quality value of the actual signal receiving capability (the signal receiving level indicator is shown on the left side recognizable by the antenna symbol), a level indicator indicating a capacity signal of the actual accumulator capacity (the accumulator capacity indicator is shown on the right side recognizable by the battery/accumulator symbol), an operator identity illustrated as “OPERATOR”, soft key and functional key settings, respectively, and further information about the current operational state of the communication terminal.

The operator identity informs the user of the communication terminal into which PLMN the communication terminal is currently subscribed, that is, which operator the PLMN operates with which the communication terminal handles communications. In homeland of the user the communication terminal is conventionally subscribed into the PLMN of that PLMN operator with which the user has signed a contract for mobile telephony services. Abroad, PLMN operators usually offer roaming with foreign PLMN operators to allow the user to also use telephony services in foreign countries and correspondingly an operator identity of a foreign PLMN operator is displayed, into which the communication terminal is allowed to be subscribed.

In a screen shot S110 a typical user interface illustration of a communication terminal is shown when the user has entered the telephone directory. Conventionally, the telephone directory sorts telephone directory entries by names in alphabetic order, wherein one name is assigned to each entry. For example illustrations, the screen shot S110 shown in FIG. 1a depicts four names: “Adam & Eve”, “Debbie”, “Juliet”, “Sweet Mary” which may be a part of the list of names contained in the telephone directory. In this example the user may have pre-selected the entry “Juliet” which is indicated by the inverted presentation of the list entry “Juliet”.

In a screen shot S120 a typical user interface illustration of a communication terminal is shown when the user has selected the pre-selected telephone directory entry “Juliet” as described with respect to screen shot S110 in order to get displayed details of the entry “Juliet”. The detail information illustrates at least a telephone number, which has been assigned to the entry “Juliet”. Additional and in accordance with an embodiment of the present invention, the detail information of the entry “Juliet” is amplified by an operator identity, which notifies the user about the PLMN operator, which serves telephony services for “Juliet” and via which PLMN “Juliet” can be connected, respectively.

The operator identity of the PLMN operator which serves telephony services for “Juliet” is an information which is not necessarily known to the user of the communication terminal such that the amplifying of the telephone number with the operator identify is optional. Correspondingly, the communication terminal provides a method for network information retrieval according to an embodiment of the invention in order to obtain this information for presenting to the user.

In a screen shot S130 a typical user interface illustration of a communication terminal is shown which illustrates a selected set of functions which allows a user to modify and manipulate the selected telephone directory entry “Juliet”. The user may access this part of user interface functionality by selecting further details in conjunction with the display illustrated with reference to screen shot S120. One of the functions dedicated to the manipulation and modification of a telephone directory entry, i.e. herein the entry “Juliet”, comprises a function “Update Network Info(rmation)” which allows a user to initiate manually a network information retrieval according to an embodiment of the invention. The network information retrieval results in at least information about the network operator and an network operator identify, such that the optional network operator identity as illustrated in screen shot S120 is available and is displayed.

Analogously to the manual initiation of network information retrieval with reference to a single telephone directory entry (embodied in view of the telephone directory entry “Juliet”) as illustrated as an example in FIG. 2a, the initiation of network information retrieval may be also accessed via a user interface, which is dedicated for modifying, managing and manipulating the telephone directory.

Referring now to FIG. 2b, in a screen shot S150 a typical user interface illustration of a communication terminal is shown which is in a standby mode. The screen shot S150 corresponds to the screen shot S100, which has been described in detail with reference to FIG. 2a.

In a screen shot S160 a typical user interface illustration of a communication terminal is shown when the user has the user interface modifying, managing and manipulating the telephone directory. A number of items are presented to the user for being selected wherein each item relates to a certain manipulating, managing and modifying function, respectively, concerning one or more telephone directory entries. As an example, the user may be allowed to select a “Search” function, an “Add name” function, an “Edit name” function and an “Update Network Info(rmation)” function. Herein, the function “Update Network Info(rmation)” is pre-selected which is indicated by the inverted presentation of the corresponding user interface item.

The “Update Network Info(rmation)” function allows a user to initiate a network information retrieval according to an embodiment of the invention, i.e. to initiate a network information retrieval with respect to one or more telephone directory entries according to an embodiment of the invention.

In a screen shot S170 a typical user interface illustration of a communication terminal is shown when the user has selected the pre-selected user interface item “Update Network Info(rmation)” as described with respect to screen shot S160 in order to get displayed further detailed functional options, which are available in conjunction with the “Update Network Info(rmation)” function. As an example, the functional options “complete update”, “partial update”, “selected update” and “automatic update” are presented.

A selection of the functional option “complete update” by the user may initiate a network information retrieval, which retrieves network information about each telephone directory entry (i.e. telephone number) which is included in the telephone directory. A selection of the functional option “partial update” by the user may initiate a network information retrieval which retrieves network information about each new telephone directory entry and each telephone entry without already existing network information, respectively, (i.e. each new telephone number and each telephone number which are not already amplified by network operator identity). A selection of the functional option “selected update” by the user may initiate a network information retrieval which retrieves network information about a set of telephone directory entries which is to be selected by the user before the network information retrieval is performed. A selection of the functional option “automatic update” by the user may instruct a network serving entity to provide network operator information autonomously by a network operator information push service. Such an autonomous service is described below in detail with reference to an example use case. The illustrated example screen shot 170 shows a pre-selected functional option “complete update”.

In a screen shot S180 a typical user interface illustration of a communication terminal is shown when the user has selected the pre-selected user interface item “complete update” as described with respect to screen shot S170. After confirmation by the user the network information retrieval considering all numbers which are included in the telephone directory is initiated.

Referring now to FIG. 2c, a screen shot S125 illustrates an alternative screen shot with reference to the screen shot S120 described above with respect to FIG. 2a. In analogy to screen shot S120 the screen shot S125 illustrates an alternative user interface illustration of a communication terminal when the user has selected the pre-selected telephone directory entry “Juliet” as described with respect to screen shot S110 in order to get displayed details of the entry “Juliet”. The detail information illustrates at least a telephone number, which has been assigned to the entry “Juliet”. In accordance with an embodiment of the present invention, the detail information of the entry “Juliet” is amplified by an operator identity, to which “Juliet” is subscribed (see above), and by charging information, on the basis of which arising costs can be calculated when a communication connection is established. The charging information may be expressed as costs per time unit such as costs per minute as illustrated such that the user of the communication device, which wants to establish a communication connection, may be in the position to at least estimate the total costs, which accumulate during making the call.

The displayed cost information may depend on date, on time and the like. The following table shall illustrate such time dependent charging which are typically defined in contracts with telephony service operators.

| | | costs |
|---|---|---|
| | period of time | per time unit |
| Working days: | 0 am-12 am | 0.39 [symbol] /min |
| | 12 am-4 pm | 0.69 [symbol] /min |
| | 4 pm-12 pm | 0.29 [symbol] /min |
| Sundays/public holidays: | 0 am-12 pm | 0.29 [symbol] /min |

The displayed cost information is derived from the available time and/or date dependent charging information, an example of which is given above in the table. The time information required for deriving is obtained from an internal clock. In order to employ a reliable time information the internal clock may be synchronized via the PLMN to which the communication terminal is subscribed. Such time synchronization is known, e.g. via NITZ (network information and time zone) service.

A screen shot S135 illustrates an alternative screen shot with reference to the screen shot S130 described above with respect to FIG. 2a. The alternative user interface illustration of a communication terminal illustrates another selected set of functions, which allows a user to modify and manipulate the selected telephone directory entry “Juliet”. The user may access this part of user interface functionality by selecting further details in conjunction with the display illustrated with reference to screen shot S125. One of the functions dedicated to the manipulation and modification of a telephone directory entry (i.e. herein the entry “Juliet”) comprises a function “cost control”, which allows a user instructing the communication terminal to display the charging information available in conjunction with the currently selected telephone directory entry (“Juliet”). The charging information displaying may have a form as presented by the charging information table shown above. Due to the limited display dimensions, the charging information may be presented to the user by a couple of presentations each containing a part thereof. The illustrated example screen shot S135 shows a pre-selected functional option “cost control”.

In a screen shot S136 an example user interface illustration of a communication terminal is shown when the user has selected the pre-selected user interface item “cost control” as described with respect to screen shot S135. The depicted screen shot S136 illustrates a first charging information entry, which is based as example on the charging information table introduced above. More particularly, this first screen shot S136 relates to the first period of time, which is defined in the charging information table. By for example selecting the “next” function assigned to a soft key of the communication terminal the next (second) first period of time which is defined in the charging information table will be displayed.

In a screen shot S137 an example user interface illustration of a communication terminal is shown when the user has selected user interface item “next” as mentioned above. Analogously and in accordance with the description above this first screen shot S137 relates to the second period of time which is defined in the charging information table. By further selection of the “next” the user is enabled to navigate/scroll through all entries in the charging information table. Consequently, the user is enabled to inform himself about estimated costs, which will arise, when he establishes a communication connection (and in particular a telephone call, respectively) to “Juliet”.

It shall be noted that the discussed charging information may also allow presenting the user of the communication terminal a reliable cost accounting after termination of a communication connection.

FIG. 3a depicts a flow chart, which illustrates an operational sequence performed by a communication terminal according to an embodiment of the method for information retrieval. For completion, FIG. 3b depicts a flow chart, which illustrates an operational sequence performed by a network serving entity according to an embodiment of the method for information retrieval.

In an operation S200, the operational sequence for network information retrieval starts on the communication terminal. The communication terminal is in particular a communication terminal which is enabled to communicate with a network serving entity which provides requested network information, especially information about PLMN operators at least comprising PLMN operator identities. More particularly, the communication terminal is a communication terminal which is enabled for communicating via a PLMN such second generation system for mobile communication, for example GSM (global system for mobile communication), an IS-95 (equal to cdmaOne; code division multiple access One), an IS-2000 (equal to cdma2000; code division multiple access 2000), PDC (personal digital cellular), PCS (personal communication system) and US-TDMA (equal to IS-136; United States time division multiple access), third generation system for mobile communication, for example UMTS (universal mobile telecommunication system), WCDMA (wideband code division multiple access), and the like. That is, the communication terminal may be a mobile phone, a mobile communicator, a mobile communication enabled PDA (personal digital assistant), a mobile communication enabled portable consumer equipment and the like.

In an operation S210, one or more telephone numbers are selected in conjunction with which the network information and especially the network operator identify is to be obtained. Examples for selecting one or more telephone numbers have been presented in detail with reference to FIG. 2a (cf. screen shot S130) and FIG. 2b (cf. screen shot S170). In particular, the one or more telephone numbers are extracted from one or more existing telephone directory entries. The selecting may be performed manually; i.e. the selecting may be performed by one or more user inputs, which identify the one or more telephone numbers, which are taken into consideration for the network information retrieval. Further, the selecting may be performed automatically, i.e. all available telephone numbers, new telephone numbers or a pre-defined selection of telephone numbers are automatically identified and selected for network information retrieval.

In an operation S220, a request for network information retrieval is coded. The request may be coded as a request message which at least contains information required for the requested retrieval, that is at least one or more telephone numbers in accordance with which the retrieval is to be performed. The coding of the request may be based on a proprietary coding or on a standardized coding method for example similar to a present or future standard. In particular, the coding of the request may be based on extended markup language (XML), a universal coding scheme and more particular may be similar to the synchronization markup language (SyncML) which has been introduced to allow comfortable automated exchange of information between a portable terminal and a serving entity. Additionally, also specialized database retrieval languages such as SQL (structured query language) may be applied for coding the request message. The above-presented enumeration of coding methods shall not be understood as limiting thereto.

In the following a coding example shall be presented on the basis of a request message employing the short message service (SMS) for conveyance. In general, short message service (SMS) is standardized such that terminal devices can cooperate. A short message is allowed to contain at least a limited set of alphanumeric symbols in its payload. The alphanumeric symbols comprises among others the characters “a” to “z”, special symbols like “,”, “<” and “>” and the numbers “0” to “9”. This text coding capability of short messages is employed for coding an appropriate request message. The payload of the request message basing on a short message may have the following form:

<MSISDN>,<MSISDN>, . . .

The tag MSISDN designates the mobile station ISDN (integrated services digital network) numbers which are for example assigned to each GSM based mobile phone. Non ISDN numbers may be coded as well. The payload of the short message serving as request message for network information retrieval contains the telephone numbers in accordance with which network information shall be retrieved. As example, the aforementioned payload coding contains two MSISDN each separated by the symbol “,” which allows to code an in principle undefined number of telephone numbers. The separation may be obtained as well by any other separating symbol. Moreover, the MSISDN may be encapsulated in braces as illustrated above but may also be marked (labeled) in any further way.

In an operation S230, the coded request message is transmitted to the network serving entity, which is able to answer the request appropriately. The coded request is transmitted via an appropriate request message bearer as aforementioned such as the short message service (SMS), via the hypertext transfer protocol stack, the wireless application protocol stack, (WAP) and the wireless session protocol (WSP) stack. In case of employing HTTP, WAP or WSP the request message may be transmitted to the network serving entity as a push and get message, respectively.

In an operation S240, a response message is received from the network serving entity. The response message contains network information in accordance with the information of the request message, which is formerly transmitted to network serving entity. The coding of the response may be based analogously to the coding of the request on a proprietary coding or on a standardized coding method for example similar to a present or future standard. In particular, the coding of the response may be based on extended markup language (XML), a universal coding scheme and more particular may be similar to the synchronization markup language (SyncML) which has been introduced to allow comfortable automated exchange of information between a portable terminal and a serving entity. Additionally, also specialized database retrieval languages such as SQL (structured query language) may be applied for coding the response message. The above-presented enumeration of coding methods shall not be understood as limiting thereto.

In the following and in analogy to the aforementioned request coding a coding example shall be presented on the basis of a response message employing the short message service (SMS) for conveyance. The payload of the response message basing on a short message may have the following form:

<MSISDN><HOME NETWORK>,<MSISDN><HOME NETWORK>, . . .

The tag MSISDN designates the mobile station ISDN (integrated services digital network) numbers which are for example assigned to each GSM based mobile phone. Non ISDN numbers may be coded as well. The payload of the short message serving as response message for network information retrieval contains the telephone numbers and the network information, which has being retrieved in accordance with the telephone numbers. In the presented example, the network information comprises a network operator identity which is designated as “HOME NETWORK” added to each telephone number MSISDN. The “HOME NETWORK” may be any alphanumerical sequence coding the network operator identity in an appropriate way in accordance with which the communication terminal is able to present an appropriate representation of the network operator identity to the user of the communication terminal.

The response message may be structured which simplifies the following decoding and parsing of the response for extracting network information. The decoding and parsing of the response should result into a number of network information records, which are unambiguously associated with certain telephone numbers. The association of network information and telephone number is required to store the received network information in conjunction with the correct telephone number. Referring back to the coding example of a response message, the structuring of the response can be appreciated on the basis of the illustrated example structuring of the response.

Each telephone number is followed by the network information, which is associated with this telephone number. Each information record including telephone number and network information is separated from each other information record by for example a symbol “,” as illustrated above.

In the following and in analogy to the aforementioned response coding a further coding example shall be presented on the basis of a response message employing the short message service (SMS) for conveyance. The payload of the response message basing on a short message comprises charge and cost information, respectively, additionally to the network operator information and may have the following form:

<MSISDN><HOME NETWORK>[<TIME RANGE><CHARGE>]ⁿ . . . ,

wherein the brackets [ ] provided with the superior symbol n should be understood as a logical operator, which indicates that the sequence contained in the brackets may be repeated n-times in an actual response message. Such an actual response message that is written out in full may have following form (if one assumes that n=3 without limiting thereto):

<MSISDN><HOME NETWORK><TIME RANGE (1)><CHARGE (1)><TIME RANGE (2)><CHARGE (2)><TIME RANGE (3)><CHARGE (3)> . . .

In the presented alternative example, the network information in conjunction with one telephone number MSISDN comprises a network operator identity, which is designated as “HOME NETWORK”, and charging information on the basis of various different periods of time, which is designated as “TIME RANGE”/“TIME RANGE (i)” and “CHARGE”/“CHARGE (i)”, wherein i is an index. The total charging information on the basis of various different periods of time should enable to upset a charging information table such as illustrated below with respect to FIG. 2c.

In an operation S250, the response is decoded and parsed, respectively, to extract the network information, which has being requested in accordance with the request message. With back reference to the response coding which is based on functionality and capability of short message service (SMS) the decoding and parsing may result in a set of records each of which comprising a telephone number (MSISDN) associated with the corresponding coded network operator identity (HOME NETWORK).

In an operation S260, the one or more received and decoded network operator identities (HOME NETWORK) are added to the one or more existing telephone directory entries on the basis of the telephone numbers (MSISDN) to which the network operator identities correspond.

In an operation S270, the operational sequence for network information retrieval is completed.

The retrieval of the network information requested by the communication terminal is operated by the network serving entity, which is capable to supply the communication terminal with the requested network information. Upon close examination of the sequence in time, the operational sequence of the network serving entity is interposed between the operation S230 and the operation S360 which relate to transmitting operation of the request and receiving operation of the response in consequence on the request, respectively. In the following the operational sequence of the method for network information retrieval performed on the network serving entity in accordance with an embodiment of the invention will be described more detailed.

In an operation S300, the operational sequence for network information service starts on the network serving entity. The start of the operational sequence may be initiated by a detection of an incoming request message for a communication terminal as described with respect to operation S230 in FIG. 3a. The network serving entity is in particular represented by one or more network information servers (serving processing devices) which operate a network information service which accepts request messages from communication terminals requesting for network information and which serves corresponding responses in accordance with the request. More particularly, the network serving entity may be a network information service provider, which operates the network information servers (serving processing devices).

In an operation S310, the network serving entity receives the request (request message) from the communication terminal. The request is coded to ask for network information, which can be supplied by the network serving entity. Therefore, the request message contains telephone numbers in accordance with the network information shall be retrieved by the receiving network serving entity. The coding of the request is described in detail with reference to operation S220 illustrated in FIG. 3a.

In an operation S320, the request is decoded and parsed, respectively, to extract the telephone numbers on the basis of which the retrieval is performed. With back reference to the request coding operation illustrated with reference to operation S220 in FIG. 3a which is based on functionality and capability of short message service (SMS) the decoding and parsing may result in a number of telephone number (MSISDN).

Due to the coding of the telephone numbers the network serving entity may have to process the extracted telephone numbers to telephone numbers which are adequate for retrieving of network information associated with the telephone numbers. Conventionally, communication terminals offering mobile communication capability are often used also abroad such that telephone numbers are often stored in the telephone directory in a universal coding scheme. Such a universal coding scheme allows employing the same telephone number independently whether the communication terminal is operated in homeland or abroad. An example of such a universal coding scheme may be explained in view of GSM. An international country-dialing code is added to the telephone number such as “+49” for Germany, “+358” for Finland, “+46” for Austria etc. The symbol “+” replaces the international preset dialing code to reach the international switching for being switched to another country. Alternatively, country specific international preset dialing codes such as “00” or “09” may have to be employed.

These international country-dialing codes may be eliminated from the telephone numbers to obtain adequate dialing numbers for network information retrieval. Moreover, such international country-dialing codes may be employed to filter the received telephone numbers such that for example telephone numbers comprising an international country-dialing code of a foreign country are sorted out in case the network serving entity supporting the network information service is only capable to provide network information of a certain country, particularly of homeland.

In an operation S330, the network serving entity retrieves the network information available in conjunction with each telephone number decoded and extracted from the received request, respectively. In particular, the network serving entity may include or may have access to a data storage which allows to resolve network information associated with a certain telephone number (MSISDN). The data storage may be a database or several databases which manage the network information, i.e. at least storing information about associations of telephone numbers (MSISDN) and network operators and network operator identities, respectively.

In an operation S340, the network serving entity codes a corresponding response in accordance with the results of the network information retrieval. The response message contains network information in accordance with the information which request message, which is formerly received by the network serving entity. The coding of the response may be performed in analogy to the coding of the request. For coding examples refer to operation S220 illustrated with respect to FIG. 3a.

In an operation S350, the network serving entity transmits the response message back to the communication terminal from which the initiating request has being received.

In an operation S360, the operational sequence for network information service is completed.

Especially in the case of employing PLMNs the communication of data between communication terminal and network serving entity may be a time-consuming and cost-intensive procedure such that the amount of data to be communicated should be reduced to a minimum. Data compression is one technique, which allows reducing the communicated amount of data. The request as well as the response may be compressed for communication to reduce the amount of request and response data. Data compression algorithms and data decompression algorithms are state of the art and any suitable compression algorithm may be applied to the coding of the request (cf. operation S220 in FIG. 3a) and response (cf. operation S340 in FIG. 3b), respectively. Furthermore a corresponding decompression algorithm may be applied to the decoding of the request (cf. operation S250 in FIG. 3a) and the response (cf. operation S320 in FIG. 3b), respectively.

The flow charts illustrated in FIG. 3a and FIG. 3b are described in view of resolving the network operators and the network operator identities on the basis of telephone numbers, respectively. The telephone numbers are extracted from the telephone directory maintained by the user in the communication terminal with which the request originates. The identification of network operators and network operator identities, respectively, is one of the network information, which may be provided on the basis of telephone numbers. A selection of enhanced methods according to further embodiments of the present invention will be explained in conjunction with following further examples.

### EXAMPLE

### Further Registered Information

In addition to the responding of network information such as network operator identities the response may also include charging information relating to the different identified network operators and therefore relating to the requested telephone numbers, respectively. The charging information may be provided to users of communication terminals as an additional service, which requires subscription by the users. In analogy to the described request for network information and the request response comprising network information, the illustrated procedure may be used for updating the charging information independently from any required updating of the network operator identity information. That means, that all following examples which mainly concern network information retrieval in view of network operator identity information also apply to network information retrieval in view of charging information. Especially, the automatic and autonomous update procedures are applicable to both sets of information.

Further, the network information contained in the response of the network serving entity may comprise country information relating to a certain telephone number which is especially of interest in case the telephone number provided in the request to the network serving entity is a foreign telephone number.

Analogously, in case a telephone number of a conventional (wire-based) telephone network geographical information may be comprised in the network information relating to the telephone number. The geographical information may comprise information about a city, information about a street and house number or even information which are for example available in conventional phonebooks or via telephone directory assistance.

Such information may be added to an existing digital telephone directory entry.

### EXAMPLE

### Automated Update

As described in the introduction of the present invention, an owner of a communication terminal may be allowed at any time changing to another PLMN operator, which serves telephony services for its communication terminal, while keeping its telephone number such that initiators of a telephone call can not reliable on a formerly given information about the network operator identity, which serves the telephony services. Conclusively, the initiators are uncertain about the costs, which arise with a telephone call. In conjunction with the screen shots of an example user interface shown in FIGS. 2a and 2b and the flow chart illustrated in FIG. 3a, a manual initiation of the network information retrieval (in particular the retrieval of the network operator(s)) with respect to a certain telephone directory entry or a selection of telephone directory entries is described in detail.

Since once obtained network information relating to a certain telephone number in the telephone directory may be incorrect due to the possibility that owners of communication terminals for example change their PLMN operator it may be advantageous to provide an automated update mechanism. The automated update mechanism may extract all telephone numbers or a pre-defined selection of telephone numbers available from the telephone directory and initiates automatically a network information retrieval as aforementioned. The corresponding response information is checked against information stored in the communication terminal and updated if necessary.

For example such an automated update mechanism may be included in the user interface as depicted in screen shot S170 referred to in FIG. 2b. An additional selectable function, which may be designated “set update interval”, can be added. The function “set update interval” may provide the possibility to the user to define a certain period in time for automated update such as one-weekly, two-weekly, four-weekly, eight-weekly etc which means that the update is operated time-triggered once a week, every two weeks, every four weeks, every eight weeks and so on. Further time-triggered periods may be user-definable such as calendar driven, i.e. for example each 1^{st} of a month.

### EXAMPLE

### Autonomous Update

As introduced with reference to screen shot S170 referred to in FIG. 2b the network information may be updated autonomously. That means the update procedure is started by the network information service without any direct initiation of the communication terminal, to which the network information provided concerns. The autonomously provided network information by be transmitted to the communication terminal by employing a data push technique which are for example well known in the field of cellular communication standards such as SMS push message.

At least one prerequisite has to be established to allow autonomous updating. The network information service, from which the autonomously provided network information origins, has to be informed about a set of telephone directory entries and corresponding telephone numbers, respectively, on the basis of which network information retrieval is to be carried out.

The set of telephone directory entries and corresponding telephone numbers, respectively, may be stored by the network information service. On the basis of the stored set of information the network retrieval may be performed after one or more periods of time (e.g. in intervals of time) and in case changes in the retrieved information (i.e. operator identities and/or charging information) are detected, a response message is coded, which comprises at least the detected information and transmitted autonomously without any request to the communication terminal. The triggering of the autonomous transmissions of the network information service may be performed analogously to the implementation described in conjunction with the automatic update procedure. The autonomous transmission may be carried out via a network information bearer, which supports push services such as SMS push, WAP push, SyncML push and the like.

This set of telephone directory entries and corresponding telephone numbers, respectively, may be supplied to the network information service by an initialization, which comprises at least one initialization request message. The information of an initialization request message may be stored in parallel to a network information retrieval such that the information is available in future. Further request messages for network information may enable to update, add and modify the stored set of telephone directory entries and corresponding telephone numbers, respectively, such that a stored set of telephone directory entries and corresponding telephone numbers, respectively, reflects the telephone directory of the communication terminal.

In order to maintain the set of telephone directory entries and corresponding telephone numbers, respectively, stored by the network information service synchronization techniques may be employed which allow for synchronizing at least parts of the telephone directory of the communication terminal and the set of telephone directory entries and corresponding telephone numbers, respectively, stored by the network information service.

It is to be noted that such an autonomous update procedure as described above is also covered by an embodiment of the method for network information retrieval according to the invention as presented with reference to FIG. 3a and FIG. 3b. An initial request message corresponds to a described request message; each of the autonomous transmitted response messages corresponds to the described response message.

### EXAMPLE

### Telephone Directory/Contact Manager

The telephone directories of the latest communication terminals are often designated as contact managers because of the functionality offered to the user. The contact managers allow managing a plurality of contacts which each offer a plurality of contact fields each being designated for a certain contact information. For example, a contact includes fields for inputting a name, at least telephone number, an address, an email address, a notice and so on.

The network information especially a network operator identity may be included into such a contact by providing a special field dedicated for containing information about the network operator. The special field designated in the following also as operator field may accept clear text information for coding a network operator identity or may provide a plurality of graphical logos of which one is displayed to inform about the identity of a network operator. The graphical logos may be logos of the PLMN operators. The operator field should be manually user-editable such that users are able to manually input a network operator identity without employing the method for network information retrieval. At least one operator field should be integrated into a contact to allow including the PLMN operator identity, which is valid in conjunction with contact field for inputting a telephone number of a communication terminal.

In an enhanced embodiment of the present invention it may be also possible to retrieve network information about conventional telephone network operators, i.e. network operator identities of conventional telephone network operators. The network information retrieval of conventional telephone network operators can be performed analogously to the presented method. In view of this enhanced embodiment and in consideration that each contact field for inputting a telephone number may contain a telephone number of a communication terminal operated in a PLMN it may be sensible to provide an operator field with each contact field containing a telephone number.

Alternatively, the coding of the network information, in particular of the network operator identity may be included into the field containing the corresponding telephone number to which the network information is associated.

A further alternative may be a coding of the network information into the name field as a clear text information or into any additional field such as the notice field.

Moreover, in case the network information includes also charging information as enlightened in an example described above it may be useful and advantageous for the user to store the received charging information for example in a charging record, which may be displayed to the user on demand for example via the user interface or which allows calculating the costs of a communication connection continuously in time or after hanging up. Such a charging record may be provided for each identified network operator and for each telephone directory entry, respectively.

### EXAMPLE

### Filter

The aforementioned method for network information retrieval according to an embodiment of the invention may be limited to network information services supporting network information retrieval of PLMN operators within the homeland of the user of the communication terminal. Due to this limited support it may be necessary or advantageous to implement filter functionality into the method for network information retrieval which primarily prevents unnecessary and cost-intensive data communication between communication terminal and network serving entity. The filter functionality may be implemented on side of the communication terminal, on side of the network serving entity or even on both sides.

An appropriate organizing of the telephone numbers stored in the communication terminal may enable the filter functionality on side of the communication terminal. Such as described with respect to the example telephone directory the organization of the telephone numbers stored in a communication terminal may be supported by dedicated field for inputting subject-oriented content. As explained a dedicated field may be provided to input a telephone number, which belongs to a mobile phone or any similar mobile communication enabled terminal. Such an organization of the telephone directory may be employed to pre-select telephone numbers belonging to mobile communication enabled terminals which is sensible in case the network serving entity only supports resolving of PLMN operator information.

The filter functionality on side of the network serving entity comprises a filtering in accordance with the network information service provided by the network serving entity. For example, the network information service could be limited to network information about homeland PLMN operators, i.e. only information about PLMN operators of the homeland of the user and information about PLMN operators only available via a homeland PLMN operator. That means, that telephone numbers including a dialing code of a foreign country and/or telephone numbers belonging to conventional telephone networks may be sorted out.

In case the network serving entity supports network information service about conventional telephone network operators the method for network information retrieval according to an embodiment of the present invention is applicable in an analogous way whiteout leaving the scope of the invention defined by the accompanying claims.

In an environment for network information retrieval being based on the method for network information retrieval according to an embodiment of the present invention, which is possibly standardized in future, requests about telephone numbers, which can not be answered due to a limited network information service of the addressed certain network serving entity, may be supported by one or more corresponding requests, which comprises those telephone numbers to one or more further network serving entities that support the required service such that for example also network information corresponding to the telephone numbers may be retrieved even in case the telephone numbers belong to foreign network operators.

### EXAMPLE

### Least Cost Routing

The method for network information retrieval may be combined with a least cost routing method of state of the art. Least cost routing is especially applicable in case the user of the communication terminal is allowed to use more than one communication networks of different network operators such as possible in countries which have a de-regularized telephone operator market, especially for conventional telephone networks. In the field of mobile telecommunication a selection of the PLMN to be used is often possible in case of using roaming partner PLMNs in foreign countries. The least cost routing enables the user to employ that communication network and that network operator, respectively, that currently offers the most reasonable charging of the communication connection desired. Therefor, the least cost routing requires information about the communication connection to be established, which in particular comprises information about the target communication network, which serves telephony services for the recipient of the communication connection. This information is provided by the aforementioned method for network information retrieval such that a sensible least cost routing is possible. Supplementary information about charging enhances further the least cost routing and its reliability.

### EXAMPLE

### Validity of Retrieved Network Information

Communication terminals and in particular mobile communication terminals comprise identification means on the basis of which the communication terminals are allowed for subscribing in a PLMN. For example communication terminals, which are capable to communicate via a global system for mobile communication (GSM) system or a universal mobile telecommunication system (UMTS), include a subscriber identification module, which stores all subscriber related information. The subscriber related information comprises for example a subscriber identification sequence, at least one ISDN telephone number, PLMN operator information defining, into which PLMN the communication terminal is allowed for subscribing, and so on. This is, by substituting a SIM in a communication terminal the PLMN operator, which serves telephony services of the communication terminal, may change. Further that mans, that all information, which are connected with the subscriber related information stored in the SIM, may get invalid. In case of a different PLMN operator, to whom the communication terminal is subscribed, the charging information may be invalid due to different charging of the other PLMN operator. Moreover, even in case the PLMN operator is not changes after substituting a first SIM by a second SIM, the contract regulations, which have being agreed with the first SIM and the second SIM, may differ. The information, which is connected with the subscriber related information, may get invalid.

Consequently, all network information or at least that part of network information, which depends on subscriber related information in conjunction with the communication terminal and the PLMN operator serving for this communication terminal, are required to be updated or may be disabled in case of subscriber identity change of the communication terminal to ensure that invalid information are not presented to the user of the communication terminal. In view of the SIM, information may get already invalid in case of simply removing the SIM without substituting it with another one.

The following block diagrams illustrate example set-ups of the communication terminal and the network serving entity on the basis of embodiments according to the present invention. The operation and functionality of the presented components allow to perform the operations of the method for network information retrieval as described with reference to FIG. 3a and FIG. 3b.

FIG. 4a shows a block diagram, which depicts components of a communication terminal according to an embodiment of the present invention. The depicted communication terminal is a microprocessor controlled terminal, i.e. a central processing unit CPU 300 controls and operates the communication terminal. An application storage 320 is provided in the communication terminal which stores several code sections containing instructions and data which allow to perform the method for network information retrieval as enlightened above in detail with respect to embodiments according to the present invention. In particular, the application storage 320 contains code sections for coding the request, decoding the response in consequence on the request and for storing the network information extracted from the response. Moreover, the application storage 320 also comprises code sections for filtering telephone numbers and for selecting telephone numbers in accordance with an embodiment of the method for network information retrieval. Alternatively, the code sections described may be implemented as one or more separate software or hardware implemented components having the corresponding functionality to allow performing an embodiment of the method. The communication terminal includes further a telephone directory 310 and a contact directory, respectively, a user interface 340 and inputting means 375 connected via an input controller 370. Presentations of the user interface have being illustrated in detail with respect to FIGS. 2a and 2b. The inputting means 375 may be keys, switches and/or actuators that allow the user to generate signals in conjunction with the input controller 370, to among others employ the user interface 340. Information of the user interface is presented to the user via a display 365 driven by a display driver 360. The communication terminal employs a communication interface 350 for communicating the request and response with the network serving entity. Herein a wireless communication interface shall be implemented having an antenna 355 for transceiving radio frequency signals corresponding to the wireless data communication via the communication interface 350.

FIG. 4b shows a block diagram, which depicts components of a network serving entity according to an embodiment of the present invention. The depicted network serving entity is a microprocessor controlled server device; i.e. a central processing unit CPU 400 controls and operates the network serving entity. An information database 410 is provided in the network serving entity which stores network information to be requested by communication terminals. A decoding component 430, a retrieval component 420 and a coding component 440 are implemented in the network serving entity to allow to perform the method for network information retrieval as enlightened above in detail with respect to embodiments according to the present invention. Not shown, the network serving entity may further include a filter component. The components may be separate software or hardware implemented components or may represent code sections, which contain instructions to perform functionality as enlightened with respect to embodiments of the method for network information retrieval according to the present invention. The components may be also contained in an application storage such as depicted and described with respect to FIG. 4a. The network serving entity employs a communication interface 450 for communicating the request and response with the communication terminal. The communication interface 450 may be capable to communicate data via a wire-based communication line and network, respectively. One or more intermediately arranged network devices might be responsible to interconnect a communication terminal enabled for wireless data communication with the network serving device enabled for wire-based data communication.

It will be obvious for those skilled in the art that as the technology advances, the inventive concept can be implemented in a broad number of ways. The invention and its embodiments are thus not limited to the examples described above but may vary within the scope of the claims.

1. Method for retrieval of network information comprising network information about network operators associated with a telephone number, said method comprising:
coding a request comprising one or more telephone numbers;
transmitting said request to a network serving entity for performing said network information retrieval;
receiving a response from said network serving entity, said response comprising network information about network operators relating to said one or more telephone numbers;
decoding said response to extract said network information; and
storing said network information in conjunction with said one or more telephone numbers.

2. Method according to claim 1, comprising:
receiving a response which is structured into at least one information record which includes one telephone number of said one or more telephone numbers and a network information relating to said one telephone number.

3. Method according to claim 1, comprising:
selecting said one or more telephone numbers from a plurality of telephone numbers stored in a telephone directory of a communication terminal.

4. Method according to claim 3, wherein said selecting is performed manually by a user of said communication terminal.

5. Method according to claim 3, wherein said selecting is performed automatically in accordance with a pre-defined selection definition.

6. Method according to claim 3, wherein said telephone directory is for storing telephone directory entries each of which includes at least a designation and a telephone number, wherein said method comprises:
identifying at least one telephone directory entry, to which said at least one information record relates, on the basis of said one telephone number that is included in said information record;
storing said network information by including said network information into said at least one identified telephone directory entry.

7. Method according to claim 1, wherein said network information comprises at least information about a network operator, in particular information about an identity of said network operator.

8. Method according to claim 1, wherein said network information comprises charging information.

9. Method for network information comprising network information about network operators associated with a telephone number, said method comprising:
receiving a request from a communication terminal, wherein said request comprises one or more telephone numbers;
decoding said request to extract said one or more telephone numbers;
retrieving network information about network operators relating to said one or more telephone numbers;
coding a response which comprises said retrieved network information; and
transmitting said response to said communication terminal.

10. Method according to claim 9, comprising:
retrieving network information by accessing a data storage which stores network information which relates to a plurality of telephone numbers.

11. Method according to claim 9, comprising:
coding said response which is structured into at least one information record including one telephone number of said one or more telephone numbers and network information which relates to said one telephone number.

12. Method according to claim 9, wherein said network information comprises at least information about a network operator, in particular information about an identity of said network operator.

13. Method according to claim 9, wherein said network information comprises charging information.

14. Method for network information comprising network information about network operators associated with a telephone number, said method comprising:
coding a request, which comprises one or more telephone numbers, in a communication terminal;
transmitting said request to a network serving entity for performing said network information retrieval;
receiving said request which comprises one or more telephone numbers;
decoding said request in said network serving entity to extract said one or more telephone numbers;
retrieving network information about network operators relating to said one or more telephone numbers;
coding a response, which comprises said retrieved network information, in said network serving entity; and
transmitting said response to said communication terminal;
receiving said response which comprises network information relating to said one or more telephone numbers;
decoding said response in said communication terminal to extract said network information; and
storing said network information in conjunction with said one or more telephone numbers.

15. Computer program product for network information retrieval, comprising loadable program code sections for carrying out the operations of claim 1, when said program code is executed on a microprocessor based component, a processing device, a terminal device, a communication terminal device, a serving device or a networked device.

16. Computer program product network information retrieval, wherein said computer program product is comprising program code sections stored on a computer readable medium for carrying out the method of claim 1, when said computer program product is executed on a microprocessor based component, a processing device, a terminal device, a communication terminal device, a serving device or a networked device.

17. Computer data signal embodied in a carrier wave and representing instructions which when executed by a processor cause the steps of claim 1 to be carried out.

18. Communication terminal comprising:
a coding component for coding a request which includes one or more telephone numbers;
a communication interface component for transmitting said request and for receiving a response in accordance with said request
a decoding component for decoding said response to extract network information; wherein network information is comprised in said response and relates to said one or more telephone numbers; and
a storing component for storing said network information into a telephone directory of said communication terminal; wherein said network information is stored in accordance with said one or more telephone numbers to which it relates.

19. Network serving entity comprising
a communication interface component for receiving a request from a communication terminal and for transmitting a response to said communication terminal;
a decoding component for decoding said request which includes one or more telephone numbers;
a retrieving component for retrieving network information in accordance with said one or more telephone numbers; and
a coding component for coding said response which comprises said retrieved network information.

20. System for network information retrieval, comprising at least one communication terminal and at least one network serving entity, wherein said at least one communication terminal comprises:
a coding component for coding a request which includes one or more telephone numbers;
a communication interface component for transmitting said request and for receiving a response in accordance with said request
a decoding component for decoding said response to extract network information; wherein network information is comprised in said response and relates to said one or more telephone numbers; and
a storing component for storing said network information into a telephone directory of said communication terminal; said network information is stored in accordance with said one or more telephone numbers to which it relates;
wherein said at least one network serving entity comprises:
a communication interface component for receiving a request from a communication terminal and for transmitting a response to said communication terminal;
a decoding component for decoding said request which includes one or more telephone numbers;
a retrieval component for retrieving network information in accordance with said one or more telephone numbers; and
a coding component for coding said response which comprises said retrieved network information.
